(19) United States
(12) Patent Application Publication
(10) Pub. No.: US 2019/0112200 A1
(43) Pub. Date: Apr. 18, 2019

(54) METHOD AND DEVICE FOR CONTROLLING WATER HARDNESS IN A DWELLING

(71) Applicant: SONATEC-INTER Sarl, Nierlet-les-Bois (CH)

(72) Inventor: Gilbert Sonnay, Lucens (CH)

(21) Appl. No.: 16/088,642

(22) PCT Filed: Oct. 31, 2016
(86) PCT No.: PCT/IB2016/056550

§ 371 Date: Sep. 26, 2018

(30) Foreign Application Priority Data
Mar. 29, 2016 (CH) PCT/CH2016/000052

(51) Int. Cl. C02F 1/00; C02F 1/44; C02F 1/66

(52) U.S. Cl. CPC C02F 1/008; C02F 1/441; C02F 2209/06; C02F 1/66; C02F 2209/055; C02F 1/444

(57) ABSTRACT

A method and device for controlling water hardness in a dwelling, including a water consumption circuit. The supply water for the dwelling is first introduced into a dynamic storage device, and then, at the outlet of the dynamic storage device, is introduced either into the water consumption circuit of the dwelling or into a purification circuit, depending upon the degree of hardness of the supply water. The purification circuit includes a pump followed by an anti-clogging device followed by an osmosis unit, a filtration device or an ultrafiltration device. Next, the “pure water” leaving the osmosis unit, the filtration device or the ultrafiltration device is reintroduced into the dynamic storage device, while the water rejected by the osmosis unit, the filtration device or the ultrafiltration device is filtered and decanted in a filtration and decantation device and then reinjected into the purification circuit by the pump. Additionally, the “pure water” from the dynamic storage tank having a degree of hardness below a predefined threshold value is introduced into the consumption circuit of the dwelling through a mixing unit so as to produce a water mixture having a hardness of between 8° fH and 12° fH. The dynamic storage circuit includes a tube wound about itself into a coil and having a length equal to or greater than 10 m.

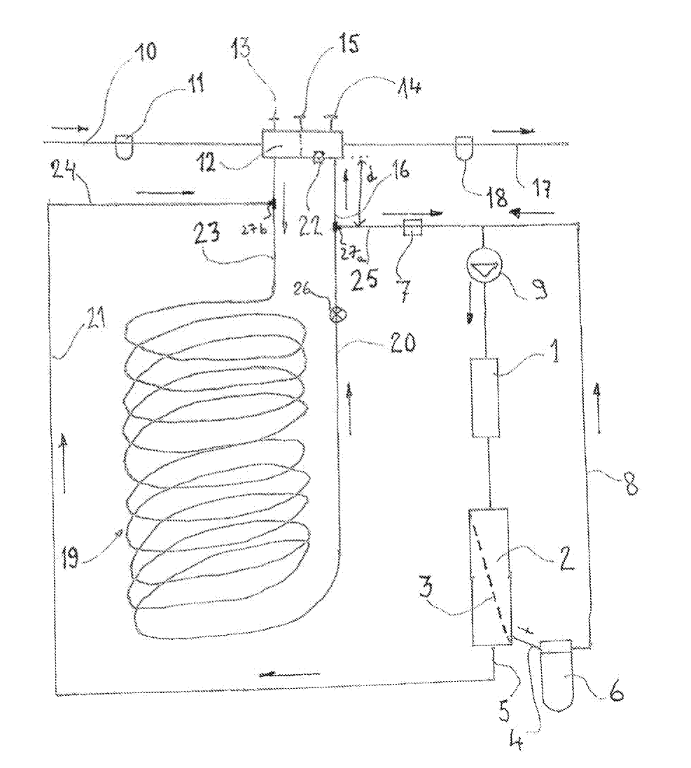

The invention relates to a method and a device for controlling water hardness in a dwelling, particularly including an osmosis unit, a filtration device or an ultrafiltration device.

In principle, an osmosis unit, a filtration device or an ultrafiltration device discharges to the sewer as much water loaded with minerals, and even sometimes a lot more, than it produces osmosed water, filtered water or ultra-filtered water, hereafter called “pure water” or “treated water”.

Such a large loss of water, given the cost of water, is no longer acceptable.

Solutions are known from documents FR 2979339 and FR 2979628, titled: “Dispositif destiné à optimiser des purificateurs d'eau par osmose inverse sans rejet d'eau à usage domestique et permettant de supprimer le plupart des interventions de maintenance” (“Device designed to optimize water purifiers by reverse osmosis without discharge of water for domestic use and allowing removal of most maintenance tasks”) and “Dispositif permettant le rinçage au moyen d'eau purifiée des membranes des purificateurs par osmose inverse sans rejet de rinçage, donc spécialement adapté aux osmoseurs sans rejet d'eau” (“Device allowing rinsing by means of purified water of the membranes of purifiers using reverse osmosis without rinsing discharge, which is therefore especially suited for reverse osmosis units without water discharge”).

The inventions described in the documents mentioned above are suitable for purifiers using reverse osmosis without water discharge for domestic use which do not have a sewer disposal circuit. However, the devices described in the French documents, mentioned above, do not take into account the quality of the water necessary for the piping, dishwashers and washing machines, particularly with regard to limestone. Indeed, the devices described only provide “pure water” to a tap, whereas the rest of the house is supplied with water that can be loaded with limestone.

Document WO 2015/010219 describes a method and a device for treating town water and/or spring water in which the “pure water” is mixed with the water which is not yet treated in a random manner. This type of procedure does not allow to guarantee the water hardness provided to the dwelling.

The aims of the invention are to provide a method and a device for controlling water hardness in a dwelling, particularly including an osmosis unit, a filtration device or an ultrafiltration device, that discharges no water during the filtration, but recycles and recovers the discharge water from an osmosis unit or from an ultrafiltration, while supplying the entire house with water that only has a small quantity of dissolved limestone, in other words water having a hardness comprised between 8° fH and 12° fH, according to the minimum standards recommended by the WHO (“fH” standing for “French Hardness”).

These aims are achieved thanks to a method for controlling water hardness in a dwelling as defined in claim 1 and thanks to a device for carrying out the method according to the invention as defined in claim 10.

The invention will be better understood and the features thereof will emerge more clearly upon reading the description of an embodiment given by way of example with reference to the appended drawing wherein:

the sole FIGURE shows a diagram of a device for controlling water hardness in a dwelling according to the invention.

As can be seen in the diagram shown in the sole FIGURE, the supply water of the dwelling arrives via a pipe 10 and passes through a pressure reducer 11, which reduces the pressure to 4 bar. Then, it arrives at the apparatus 12. The apparatus 12 is a unit which comprises three valves 13, 14 and 15, a safety gate and an adjusting screw 22 for mixing the waters. This apparatus can be purchased from “ROBINEX SA” at CH-5035 Unterenfelden (Switzerland), for example under the name “Interpass”. Said apparatus 12 has been modified by the inventor with regard to a seat valve 15. On the left-hand side of the drawing, the apparatus 12 comprises a first valve 13, which allows to admit the water through a duct 23 into a dynamic storage device 19.

The dynamic storage device 19 is made up of a flexible tube wound about itself into a coil. In another embodiment, it is conceivable to use a straight tube instead of the tube wound into a coil. Said tube will be, for example, made of any known material for a tube for sanitary use and will have a length l equal to or greater than 10 m and an inner diameter D comprised between 1.5 cm and 4 cm, which will be suited to the quantity of water used in the dwelling and which will define a maximum storage volume Vmax, where Vmax=π×(D/2)²×l. Thus, a tube length l of 10 m and an inner diameter D of 2 cm will lead to a dynamic storage capacity of: 3.1416×0.01×100=3.1416 liters. A length l of 100 m will lead to a storage capacity of 31.1416 liters of “pure water”, which corresponds to approximately 60 l of usable water having a hardness of 100 ppm (parts per million) (which corresponds to 10⁻⁴ mol/l of CaCO3) for an initial hardness of 350 ppm. Moreover, choosing the inner diameter of the tube in the range mentioned above will prevent a liquid newly introduced into the tube from mixing with the liquid already contained in the tube. This will in particular ensure that, following consumption of water stored in the tube, the untreated supply water intended to fill the empty space created by the consumed water in the tube does not mix with the treated water already stored in the tube, which would lead to an unacceptable rise in the hardness of this treated water. It would otherwise be necessary to carry out another purification treatment of this water such that the hardness thereof again falls below a predefined threshold limit.

The apparatus 12 has, in the central part thereof, a seat valve 15 calibrated with 1 bar difference, which seat valve has been added by the inventor to the “Interpass” apparatus, and which allows the “pure water” to mix with the supply water of the dwelling so as to have a hardness comprised between 8° fH and 12° fH and a pH stabilized between 6.8 and 7.4. Moreover, the apparatus 12 includes an adjusting screw 22 allowing to produce the desired hardness, and the valve 14 controls the inlet circuit to supply the dwelling through the pipe 17.

The pressure of the consumer water will be controlled by an apparatus 18 which will keep it at 4 bar.

The water arriving through the pipe 10, passes from the unit 12 into the dynamic storage device 19 through the duct 23 as indicated by the arrows drawn next to the ducts in the drawing. The water in the duct 23 receives, from duct 24, “pure water” before being introduced into the dynamic storage device 19. The “pure water” arriving through the duct 24 comes from a water purification circuit through the ducts 5 and 21.

The water purification circuit comprises a pump 9, an anti-clogging device 1, for example as described in document WO 86/04887, an osmosis unit 2 having a membrane 3 and a filtration and decantation device 6. Upon exiting the anti-clogging device 1, the water is sent into an osmosis unit 2 having a membrane 3, but could also be sent into a filtration device or into an ultrafiltration device. The “pure water” exiting the osmosis unit 2, the filtration device or the ultrafiltration device is sent through the duct 5 into a duct 21 and then through the duct 24 into the duct 23 in order to end up in the dynamic storage device 19, waiting to be used or to be reinjected into the purification circuit.

The water purification circuit further comprises a duct 4 supplied with the water that is discharged by the osmosis unit 2, or by a filtration device or an ultrafiltration device, and that is injected into a filtration and decantation device 6, that is commercially available and that is within the knowledge of a person skilled in the art. Then, the water flowing through the duct 8 will be mixed with the water exiting the dynamic storage device 19 through the ducts 20 and 25 into the pump 9. A nonreturn flap 7 preventing water from the purification circuit from entering the supply circuit of the dwelling 17 is provided on the duct 25. The filtration and decantation device 6 will be regularly cleared of the waste, without loss of water, and said waste will be dried and used particularly for making construction materials. It will be advantageous to equip the filtration and decantation device 6 with filters of 25 μm or less than 25 μm. Indeed, surprisingly, it has been observed that such filters allow to lead to a better filtration of the water, while preventing the formation of obstructions.

The water will flow in the purification circuit for as long as the pump 9 will be activated and no water will be discharged to the sewer. As a result, the water in the dynamic storage device will become “pure water”. As soon as the water hardness TH measured in the duct 20 by means of a sensor 26 will be less than or equal to a threshold hardness TH₀, an analyzing and controlling unit (not shown) designed to receive and process measurements carried out by the sensor 26 will then control the pump 9 to stop such that water will no longer flow in the purification circuit. The pump 9 will be restarted once the sensor 26 detects a hardness TH greater than the threshold hardness TH₀. This restart will generally only occur when there is an additional introduction of untreated supply water at the duct 23. The threshold hardness TH₀ will be comprised between 80 and 120 ppm, and, preferably, will be equal to 100 ppm. As soon as water is consumed in the house, the “pure water” will exit the dynamic storage device 19 through the duct 20, will enter the unit 12 through the duct 16 and the valve 14, and said “pure water” will be mixed with supply water by an adjusting screw 22 mixing the waters to reach a hardness comprised between 8° fH and 12° fH and a pH stabilized between 6.8 and 7.4, according to the applicable standards. Moreover, a seat valve 15, calibrated with one bar difference, is provided in the unit 12, for the case where an extremely large consumption would take place in the dwelling. The ducts 16, 20 and 25 will be connected together by means of a T-junction 27a. This T-junction 27a will be arranged at a distance d away from the mixing unit 12, d being advantageously equal to or greater than 2.5 cm. Indeed, it has been noted that, when the T-junction 27a is positioned at less than 2.5 cm from the mixing unit, water was able to flow between the outlet of the duct 16 and the inlet of the duct 23 via the mixing unit 12, thus disrupting the general operation of the device according to the invention. Similarly, the ducts 23 and 24 will be connected together by means of a T-junction 27b, said junction being advantageously arranged at least 2.5 cm away from the mixing unit 12.

As can be noted, this results in a simple device, that is therefore inexpensive, discharging no water to the sewer and allowing to adjust the water hardness in an extremely precise manner. The device according to the invention allows to supply a dwelling with water in accordance with the current standards.

1.-16. (canceled)

17. A method for controlling water hardness in a dwelling, comprising the following steps:
a) introducing untreated supply water into a dynamic storage device which can contain a maximum storage volume of liquid;
b) filling the dynamic storage device until said maximum storage volume is reached;
c) measuring a hardness of the water at an outlet of the dynamic storage device;
d) comparing the measured hardness with a threshold hardness and proceeding either with following steps e) to h) when the measured hardness is greater than the threshold hardness or with following steps i) to m) when the measured hardness is less than or equal to the threshold hardness;
e) transporting the water from the outlet of the dynamic storage device toward a purification circuit and introducing the water into the purification circuit;
f) purifying the water by the purification circuit so as to provide treated water having a lower dissolved limestone quantity;
g) reintroducing the treated water into the dynamic storage device;
h) repeating steps b) to d);
i) transporting the water from the outlet of the dynamic storage device toward a mixing unit;
j) introducing the water, in a controlled manner, into the mixing unit by means of an adjusting screw;
k) mixing, in the mixing unit, the water introduced at step j) with untreated supply water so as to produce a water mixture having a hardness comprised between 8° fH and 12° fH;
l) taking the water mixture produced at step k) out from the mixing unit and introducing said water mixture into a water consumption circuit;
m) repeating steps a) to d);
wherein the dynamic storage device is made up by a tube having a length equal to or greater than 10 meters and an inner diameter comprised between 1.5 centimeters and 4 centimeters, the length and the inner diameter being chosen in order to provide the dynamic storage device with the maximum storage volume, the inner diameter of said tube preventing mixture of a liquid newly introduced into the dynamic storage device with a liquid already contained in said dynamic storage device.

18. The method of claim 17, wherein the tube is wound about itself into a coil.

19. The method of claim 17, wherein the outlet of the dynamic storage device is connected to the mixing unit by means of two successive ducts connected together by means of a T-junction, to which a third duct leading to the purification circuit is also connected.

20. The method of claim 19, wherein the T-junction is distanced from the mixing unit by at least 2.5 centimeters.

21. The method of claim 17, wherein the purification circuit comprises:
a pump which is capable of introducing water coming from the dynamic storage device into said purification circuit;
an anti-clogging device;
an osmosis unit, a filtration device or an ultrafiltration device which is located downstream of the anti-clogging device; and
a filtration and decantation device having an outlet connected to an inlet of the purification circuit;
wherein the osmosis unit, the filtration device or the ultrafiltration device is capable of treating the water introduced by the pump so as to provide the treated water intended to be transported toward an inlet of the dynamic storage device by means of one or more ducts and untreated water intended to be injected into the filtration and decantation device, and then reintroduced at the outlet of the filtration and decantation device into the inlet of the purification circuit.

22. The method of claim 21, wherein the filtration and decantation device uses filters less than or equal to 25 micrometers.

23. The method of claim 21, wherein the pump pressurizes the water to 7 to 10 bars.

24. The method of claim 17, wherein the mixing unit includes three valves, a first valve through which the untreated supply water flows before being introduced into the dynamic storage device at step a), a second seat valve allowing the untreated supply water to pass directly into the water consumption circuit, and a third valve opening and closing the passage for the treated water coming from the dynamic storage device.

25. The method of claim 17, wherein the threshold hardness is between 80 and 120 ppm.

26. The method of claim 25, wherein the threshold hardness is equal to 100 ppm.

27. A device for controlling water hardness in a dwelling, comprising:
a dynamic storage device designed to store a maximum storage volume of liquid;
at least one duct for the arrival of untreated supply water, which duct is designed to introduce untreated supply water into the dynamic storage device;
a sensor designed to measure the hardness of the water at an outlet of the dynamic storage device;
a mixing unit designed to mix water coming from the outlet of the dynamic storage device with the untreated supply water so as to produce a water mixture having a hardness comprised between 8° fH and 12° fH;
a purification circuit designed to purify water and to provide treated water having a lower dissolved limestone quantity, which purification circuit comprises a pump capable of introducing water coming from the dynamic storage device into said purification circuit;
at least a first water flow duct designed to transport the water from the outlet of the dynamic storage device to the purification circuit;
at least a second water flow duct designed to transport the water from the outlet of the dynamic storage device to the mixing unit;
an analyzing and controlling unit designed to compare the hardness measured by the sensor with a threshold hardness and control the pump of the purification circuit such that the pump is operating when the hardness measured by the sensor is greater than the threshold hardness, which causes the water to flow in the first water flow duct, and is stopped when the hardness measured by the sensor is less than or equal to the threshold hardness, which causes the water to flow in the second water flow duct;
at least a third water flow duct designed to reintroduce the treated water produced by the purification circuit into an inlet of the dynamic storage device; and
a water consumption circuit designed to be supplied with the water mixture produced at an outlet of the mixing unit;
wherein the dynamic storage device is made up by a tube having a length equal to or greater than 10 meters and an inner diameter comprised between 1.5 centimeters and 4 centimeters.

28. The device of claim 27, wherein the tube is wound about itself into a coil.

29. The device of claim 27, wherein the outlet of the dynamic storage device is connected to the mixing unit by means of a fourth water flow duct connected to the second water flow duct, and wherein the second and fourth water flow ducts are connected together by means of a T-junction, to which the first water flow duct leading to the purification circuit is also connected.

30. The device of claim 29, wherein the T-junction is distanced from the mixing unit by at least 2.5 centimeters.

31. The device of claim 27, wherein the purification circuit further comprises:
an anti-clogging device;
an osmosis unit, a filtration device or an ultrafiltration device which is located downstream of the anti-clogging device; and
a filtration and decantation device having an outlet connected to an inlet of the purification circuit;
wherein the osmosis unit, the filtration device or the ultrafiltration device is capable of treating the water introduced by the pump so as to provide the treated water intended to be transported toward the inlet of the dynamic storage device by means of the third water flow duct and untreated water intended to be injected into the filtration and decantation device, and then reintroduced at the outlet of the filtration and decantation device into the inlet of the purification circuit.

32. The device of claim 31, wherein the filtration and decantation device uses filters less than or equal to 25 micrometers.

33. The device of claim 27, wherein the mixing unit includes three valves, a first valve through which the untreated supply water flows before being introduced into the dynamic storage device, a second seat valve allowing the untreated supply water to pass directly into the water consumption circuit, and a third valve opening and closing the passage for the treated water coming from the dynamic storage device.
